(19) United States
(12) Patent Application Publication
(10) Pub. No.: US 2016/0116992 A1
(43) Pub. Date: Apr. 28, 2016

(54) HAND-HELD INPUT DEVICE FOR A COMPUTER

(71) Applicant: William James McDermid, Niwot, CO (US)

(72) Inventor: William James McDermid, Niwot, CO (US)

(21) Appl. No.: 14/526,369

(22) Filed: Oct. 28, 2014

(51) Int. Cl. G06F 3/02; G06F 3/041; G06F 3/0488; G06F 1/16; G06F 3/038

(52) U.S. Cl. CPC G06F 3/0219; G06F 1/1632; G06F 1/1626; G06F 3/038; G06F 3/04886; G06F 3/0412

(57) ABSTRACT

A method and apparatus are provided for user input to a computer. The apparatus consists of movable grips with multiple axes of motion. The grips include means for holding the device while keeping a user's fingers and thumbs free to activate touch sensitive areas on the grips. Both the positions of the grips and the location of touches are used to determine the input codes sent to the computer.

### CROSS REFERENCE TO RELATED APPLICATIONS

This application is related to U.S. Pat. No. 8,810,536 filed by the same inventor on Nov. 2, 2011, which is incorporated herein by reference.

This non-provisional application claims priority to U.S. provisional application 61/896,127 filed on Oct. 18, 2013, which is incorporated herein by reference.

### BACKGROUND OF THE INVENTION

1. Field of the Invention

This invention relates to a method of typing and pointing on a computer.

2. Statement of the Problem

A common method for entering data into a computer requires two devices: a keyboard and a separate pointing device. This requires users to remove their hands from one device to use the other, thereby slowing down the human-computer interaction. Furthermore, to be used effectively, these devices often require a horizontal surface to rest upon which limits their viability in mobile applications. A hand-held input device with touch sensitive regions attached to moveable grips is one attempt to address these limitations. In a pointer mode, the movement of the grips can control a cursor, while in a typing mode, the position of the grips can be used to set the current definition for the touch-sensitive areas under a user's fingers. The current generation of these devices have a single axis of movement for the grips which limits their ergonomic adaptability in typing mode and their effectiveness in pointing mode. The limitation on movement is necessary in part because the device is held by pressing in of the hands to free the fingers from gripping so they can be used for typing.

### SUMMARY OF THE SOLUTION

The present invention solves the above and other problems by adding means for the device to rest in a user's hands and adding additional axes of movement to the grips. The means for resting the device may include pegs or molded contours positioned in the crook between a user's thumb and index finger. The means for resting may also include means that hook around the back of a user's hand to more positively affix the device to the hands. With these improved holding means, additional axes of motion can be added to the grips while still keeping the fingers free from gripping so they can be used for typing.

### Aspects

An aspect of the invention is how it is shaped to allow it to rest in a user's hands without the need for fingers to grip it.

Preferably, the shape includes protuberances that fit in the crook between the thumbs and index fingers of a user's hands.

Preferably, the protuberances can be retracted when not needed to reduce the size of the device.

Preferably the invention includes means that hook around the backs of a user's hands to more positively affix the invention to a user's hands.

Another aspect of the invention is how the grips have multiple axes of motion.

Preferably, the axes of motion allow for a back and forth rocking motion and an in and out rolling motion.

Preferably, the invention has a pointer mode where the rocking motion moves the display focus on the plane of the display while the rolling motion moves the focus into and out of the display by zooming in and out.

Preferably, the invention has a typing mode where the rolling motion allows a user to position the grips in a comfortable position for typing while the rocking motion is used to select a current set of key definitions for the touch sensitive areas under a user's fingers.

Preferably, while in typing mode, the rolling motion has multiple positions that can emulate the shift, ctrl, and alt functions found on common computer keyboards.

### DESCRIPTION OF THE DRAWINGS

The above and other advantages and features of the invention may be better understood from a reading of the detailed description taken in conjunction with the drawings. The same reference number represents the same element on all drawings.

FIG. 1 is an isometric view showing an example of how a tablet computer is placed in the input device.

FIG. 2A is a front view of the invention resting in a user's hands in a neutral configuration with the rocking position at 15 degrees and the rolling position at 30 degrees. FIG. 2B is a front view of the invention in a compact configuration with the rocking position fully closed and the rolling position fully in.

FIG. 3A is a back view of the invention resting in a user's hands in a neutral configuration with the rocking position at 15 degrees and the rolling position at 30 degrees. FIG. 3B is a back view of the invention in a compact configuration with the rocking position fully closed and the rolling position fully in.

FIG. 4A is a back isometric view of the invention with the protuberances extended. FIG. 4B is a back isometric view of the invention with the protuberances refracted.

FIG. 5 is a back view of the invention with protuberances that hook around a user's hands.

FIGS. 6A, 6B, and 6C are front views of the invention showing the grips in various rocking positions.

FIGS. 7A, 7B, and 7C are top views of the invention showing the grips in various rolling positions.

FIG. 8A is a front view of the invention in pointer mode with the grip rocking position moving the display focus up. FIG. 8B shows the grip rocking position moving the display focus down. FIG. 8C shows the grip rocking position moving the display focus left. FIG. 8D shows the grip rocking position moving the display focus right. FIG. 8E shows the grip rolling position moving the display focus in. FIG. 8F shows the grip rolling position moving the display focus out.

FIG. 9 is an isometric view of the device where the rolling position is in an ergonomic typing position while the rocking position is selecting a “home row” key set.

FIG. 10 is a schematic diagram of the electronics of the device.

FIG. 11 is a flow chart of a method for determining which input codes to send to a tablet computer based on key states and grip positions.

### DETAILED DESCRIPTION OF THE INVENTION

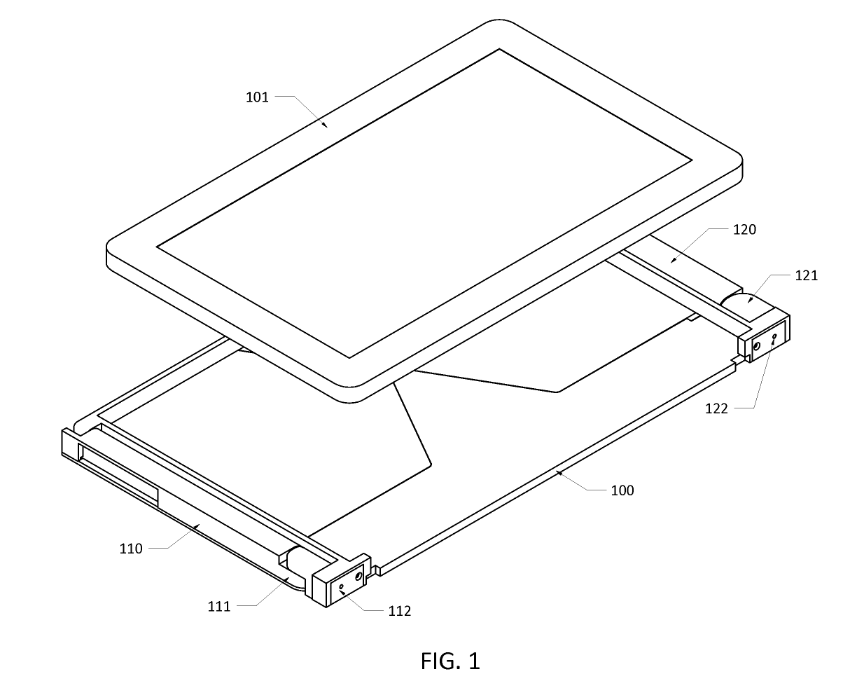

FIGS. 1-11 and the following description depict specific exemplary embodiments of the invention to teach those skilled in the art how to make and use the best mode of the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 shows a computer input device 100 that is designed to accept tablet computer 101. Computer input device 100 has grips 110 and 120 mounted on the left and right sides respectively. The grips 110 and 120 are mounted to device 100 at rocking pivot points 111 and 121 respectively and rolling pivot points 112 and 122 respectively. These mounts allow grips 110 and 120 to move independently about these pivot points along these two axes of motion. As drawn, both grips are able to both roll and rock up to 90 degrees.

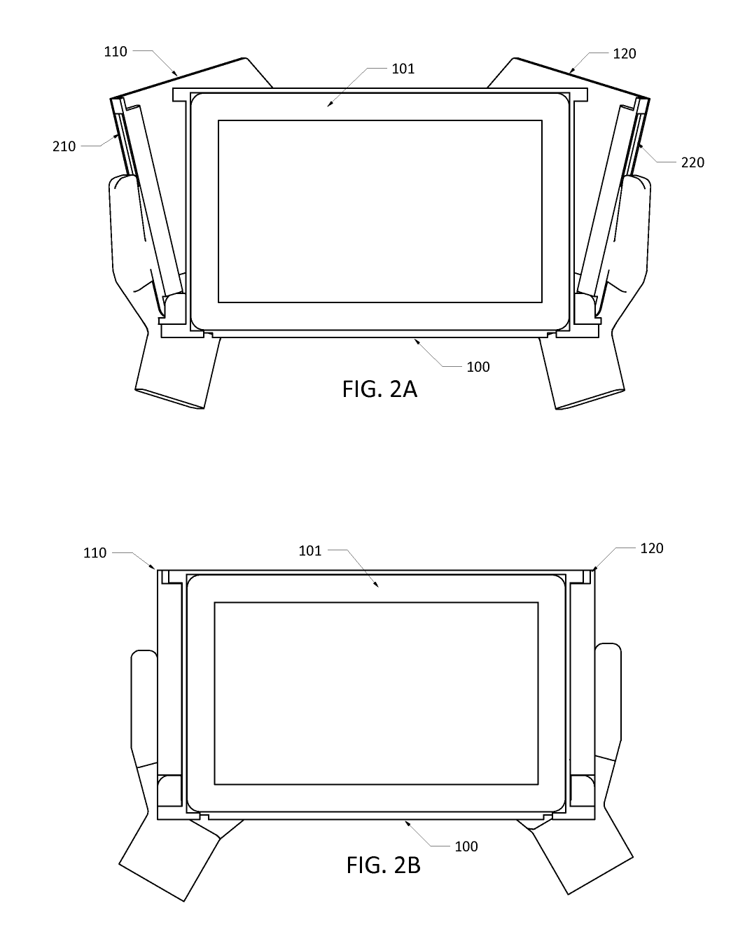

FIG. 2A shows the computer input device 100 resting in a user's hands with grips 110 and 120 in a neutral configuration with the rocking position at 15 degrees and the rolling position at 30 degrees. FIG. 2B shows the computer input device 100 with grips 110 and 120 in a compact configuration with the rocking position fully closed and the rolling position fully in. FIG. 2A shows touch sensitive areas 210 and 220 on the sides of grips 110 and 120 respectively. Touch sensitive area 210 is located so it can be activated by a user's left thumb while touch sensitive area 220 is located so it can be activated by a user's right thumb.

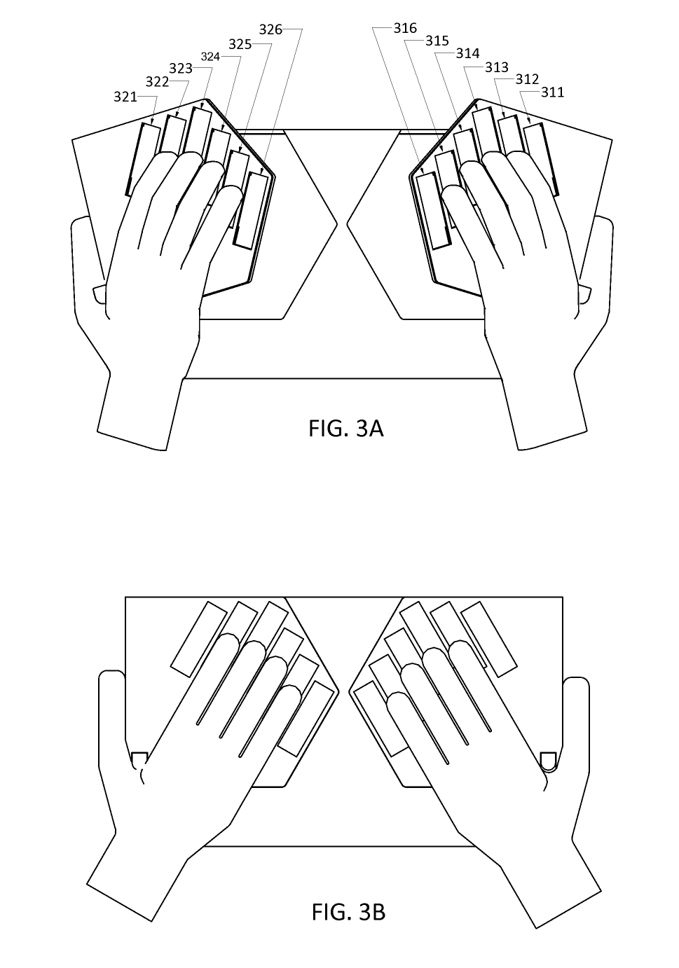

FIG. 3A and FIG. 3B show the back side of the same user holding the same device in the same manner as in FIG. 2A and FIG. 2B respectively. The fingers of the left hand (shown on the right in this perspective) are over touch sensitive areas 312 through 315. The index finger can rotate to access switch 311 and the little finger can rotate to access key 316 without requiring any hand movement. In a likewise manner, the fingers of the user's right hand can access switches 321 through 326.

All fourteen touch sensitive areas can be implemented by various means including touch pads, long piano type keys, or smaller key switches that slide up and down to be positioned to suit user preferences.

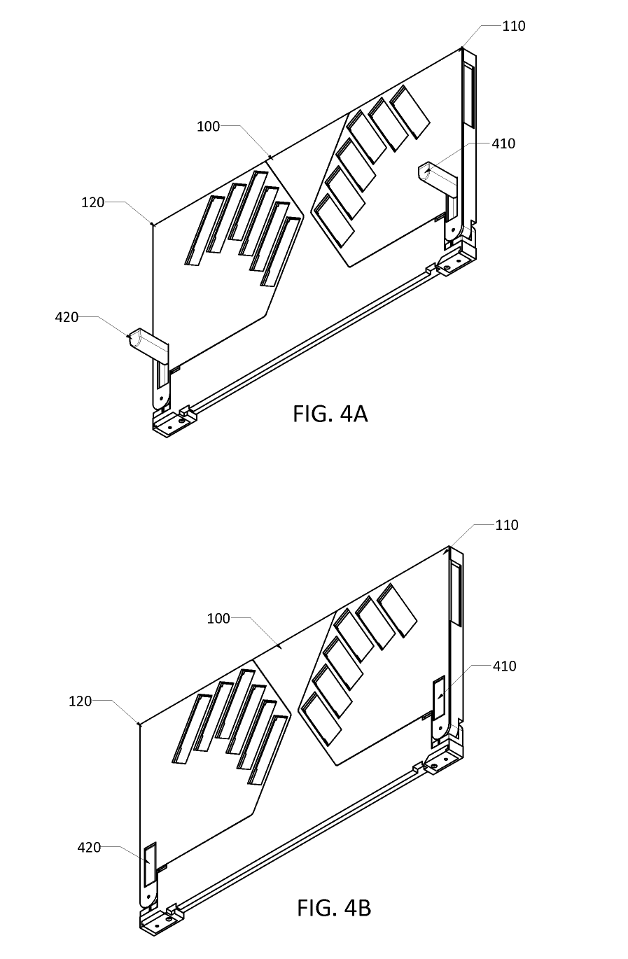

FIG. 4A shows device 100 with protuberances 410 and 420 extended from grips 110 and 120 respectively. These protuberances are located to fit in the crook between a user's index finger and thumb to support the weight of device 100 without requiring the user to grip the device with their fingers. FIG. 4B shows the same device with the protuberances retracted to reduce the envelope of the device for storage. Or, in some usage scenarios, the protuberances may not be necessary when the device is in use.

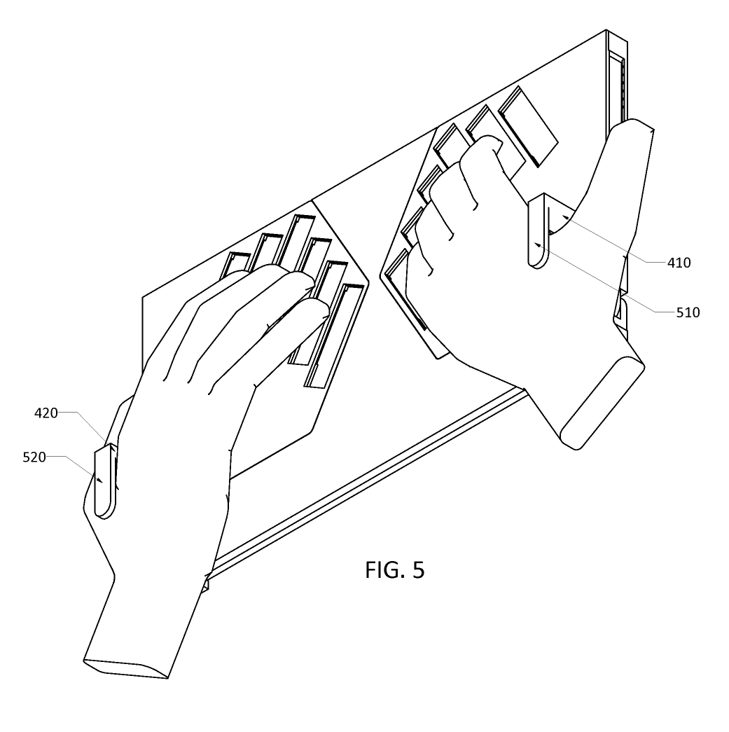

FIG. 5 shows protuberances 410 and 420 fitted with hooks 510 and 520 respectively. Hooks 510 and 520 wrap around the backs of a user's hands to more positively affix the device to a user's hands. Holding means 510 and 520 might also be implemented as straps that wrap all the way around the back of a user's hands.

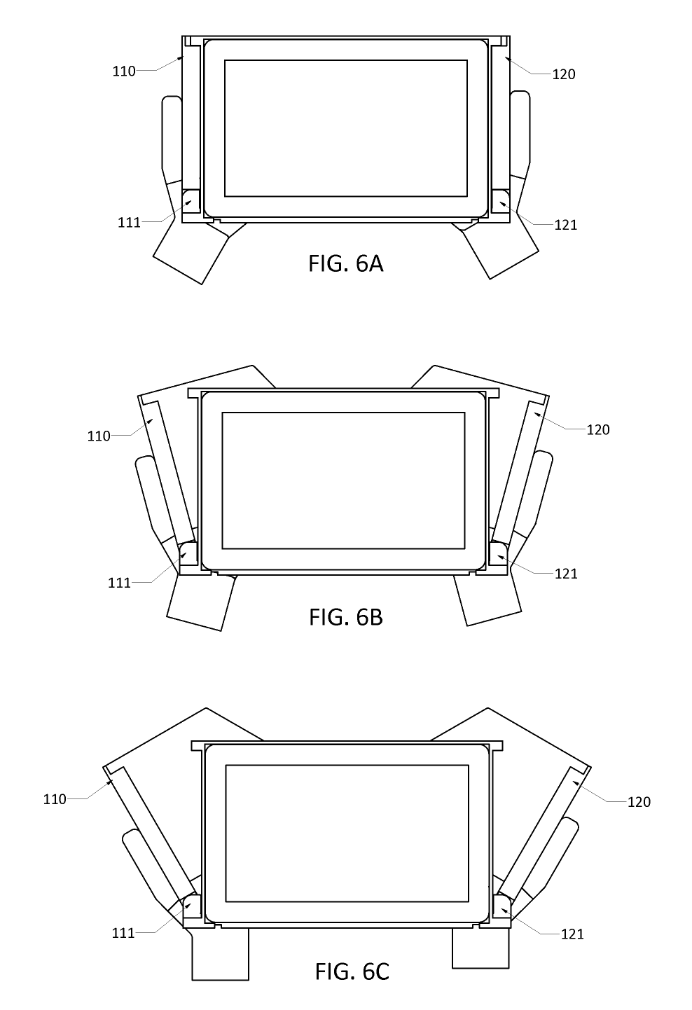

FIG. 6A through FIG. 6C shows how grips 110 and 120 are free to move around pivots 111 and 121 respectively. FIG. 6A shows the grips at 0 degrees of rocking, FIG. 6B shows the grips at 15 degrees of rocking, and FIG. 6C shows the grips at 30 degrees of rocking.

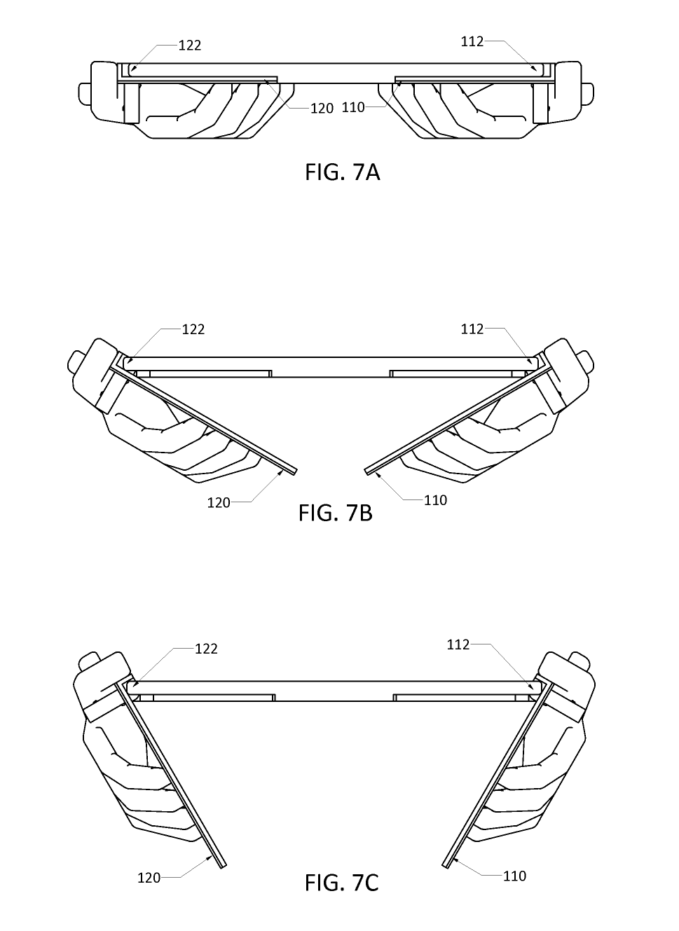

FIG. 7A through FIG. 7C shows how grips 110 and 120 are free to move around pivots 112 and 122 respectively. FIG. 7A shows the grips at 0 degrees of roll, FIG. 7B shows the grips at 30 degrees of roll, and FIG. 7C shows the grips at 60 degrees of roll.

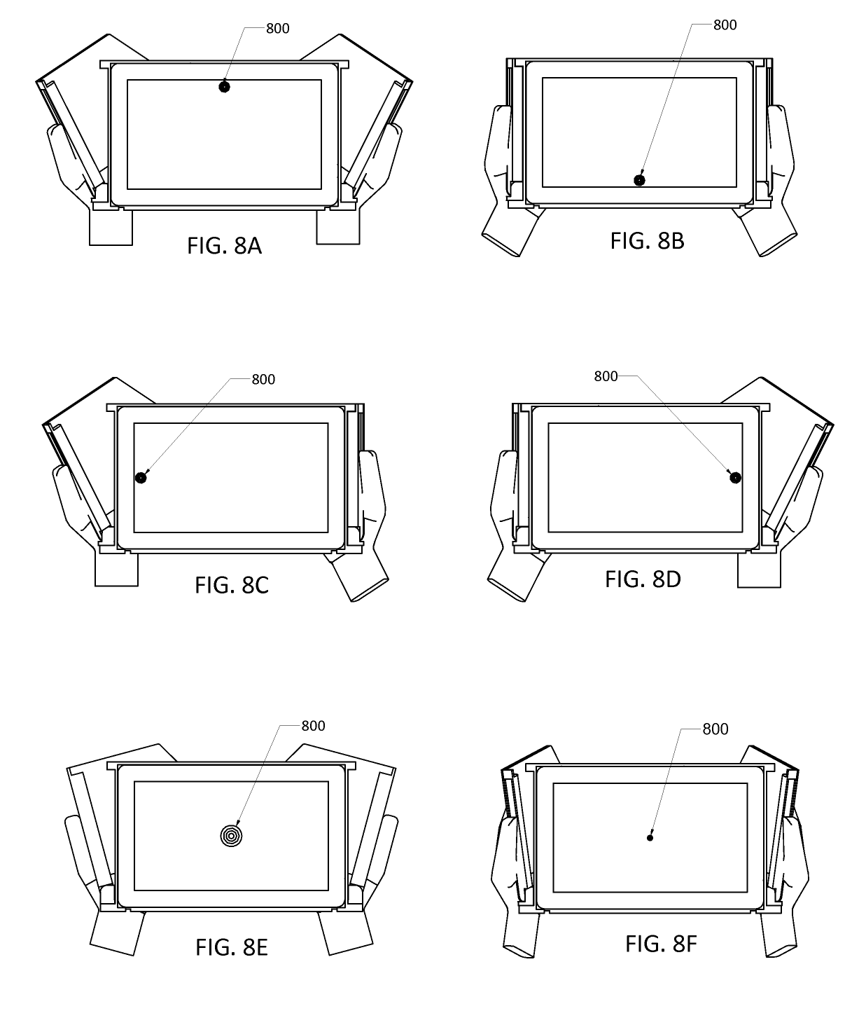

FIG. 8A through FIG. 8F show one possible interpretation of grip positions when computer input device 100 is used in pointer mode. Grip rocking motion moves the display focus 800 anywhere in the plane of the display. FIG. 8A shows how rocking the grips out moves the display focus up and FIG. 8B shows how rocking the grips in moves the display focus down. FIG. 8C shows how rocking the grips left moves the display focus left and FIG. 8D shows how rocking the grips right moves the display focus right. Grip rolling motion moves the display focus 800 into and out of the display. FIG. 8E shows how rolling the grips in moves the display focus in by zooming in the display and FIG. 8F shows how rolling the grips back moves the display focus back by zooming out the display.

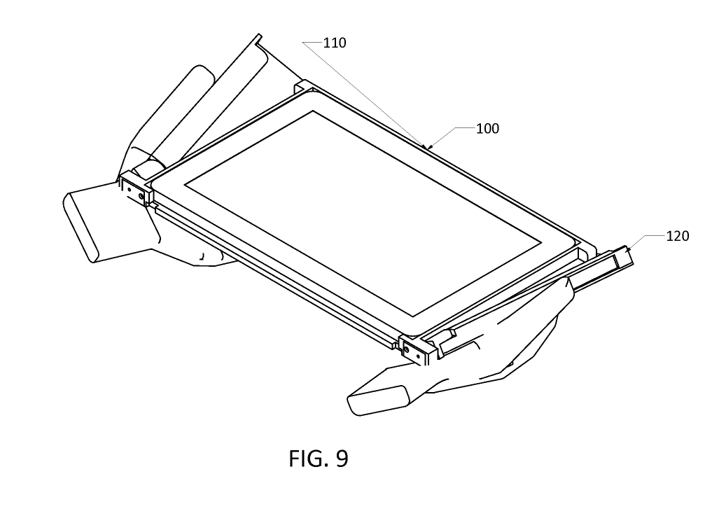

FIG. 9 shows computer input device 100 resting in a user's hands in an ergonomically preferred configuration for using the device in typing mode. Grips 110 and 120 rolling position is 30 degrees. The demonstrated rocking position of 15 degrees assigns the home row keys of a QWERTY keyboard to touch sensitive areas 311 through 316 for the left hand and 321 through 326 for the right hand. Different key assignments are made to the touch sensitive areas when the grips are in the 0 degree or 30 degree rocking position. Likewise, modifier key assignments such as those normally provided by the shift and ctrl keys of a traditional computer keyboard can be made to the touch sensitive areas when the grips are in the 15 degree or 45 degree rolling position.

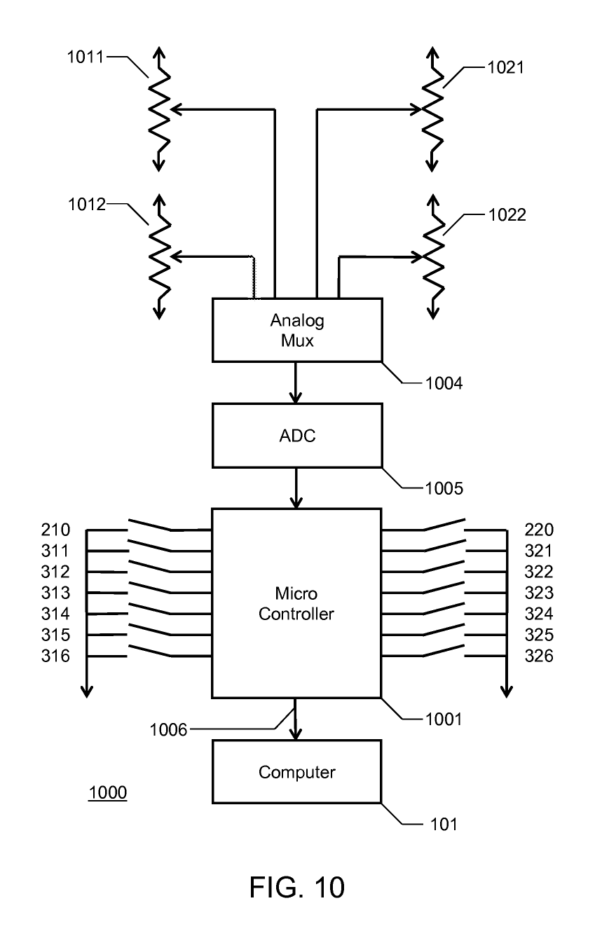

FIG. 10 shows a schematic diagram of circuit 1000 which is a possible implementation for the electronics of the invention. The core of the electronics is micro-controller 1001. Micro-controller 1001 is connected to computer 101 via communications channel 1006. In a preferred embodiment, channel 1006 is a wireless connection. Touch sensitive areas 210, and 311 through 316 from the left grip 110, and touch sensitive areas 220, and 321 through 326 from the right grip 120 connect directly to micro-controller 1001 where they are monitored for state changes. Potentiometers 1011 and 1012 indicate the position of pivots 111 and 112 respectively that connect grip 110 to computer input device 100. Likewise, potentiometers 1021 and 1022 indicate the position of pivots 121 and 122 respectively that connect grip 120 to computer input device 100. The voltage on the wiper pins of potentiometers 1011, 1012, 1021, and 1022 are read by analog to digital converter 1005 by way of analog multiplexor 1004.

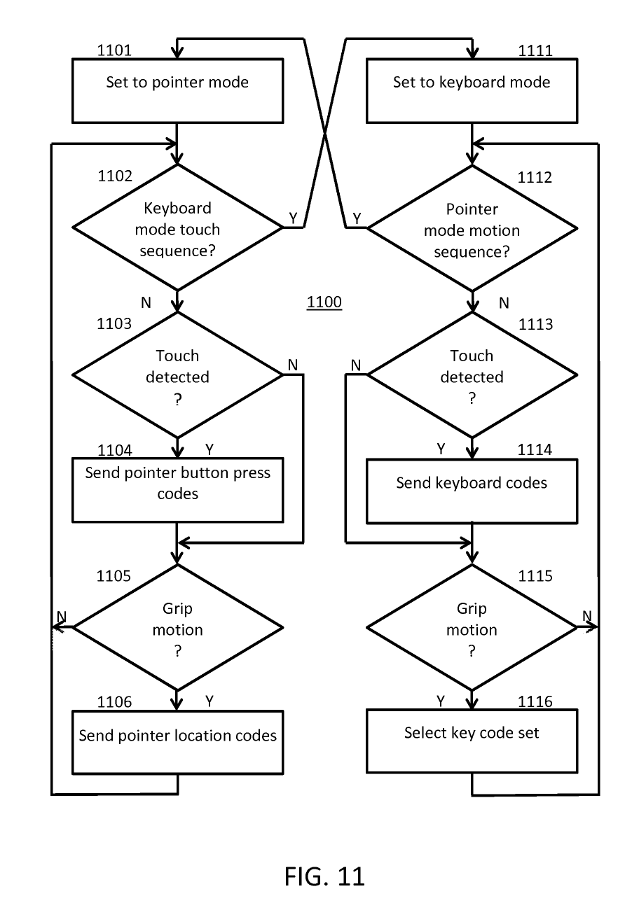

FIG. 11 illustrates a flow chart of process 1100 running on micro-controller 1001 to monitor grip positions and touch states to determine input codes to send to computer 101. At any given time process 1100 is in either pointer mode described in steps 1101 through 1106, or in keyboard mode described in steps 1111 through 1116. Process 1100 is a continuous loop so an explanation of its operation can begin at any step. At step 1101 micro-controller 1001 enters into pointer mode and continues to step 1102 where it checks for a specific touch sequence to determine if it should enter keyboard mode. If it is to enter keyboard mode, processing continues at step 1111 described below, otherwise processing continues at step 1103. Step 1103 checks for a touch and, if found, returns pointer button press codes at step 1104. Processing then continues at step 1105 where the micro-controller looks for grip motion and if found returns pointer location updates at step 1106. Processing then returns to step 1102.

If step 1102 finds a proper touch sequence for entering keyboard mode, then processing continues to step 1111 where the micro-controller enters keyboard mode. Processing continues at step 1112 where the micro-controller checks for a specific grip motion sequence to determine if it should return to pointer mode. If it is to enter pointer mode, processing returns to step 1101 described above, otherwise processing continues at step 1113. Step 1113 checks for touches and, if found, returns key press codes at step 1114. Processing then continues at step 1115 where the micro-controller looks for grip motion and if found assigns a new set of codes to the touch areas at step 1116 based on the new grip position. Processing then returns to step 1112.

Although specific embodiments were described herein, the scope of the invention is not limited to those specific embodiments. The scope of the invention is defined by the following claims and any equivalents therein.

I claim:

1. A method for a user to hold a computer pointing and typing input device where the fingers and thumbs are not required for gripping so remain free for actuating touch sensitive areas and where said method is by protuberances on the back of the apparatus that rest in the crook between the thumbs and index fingers of a user's hands.

2. The method of claim 1, where additional means wrap around the back of a user's hands to more positively affix the computer input device to a user's hands.

3. The method of claim 1, where the protuberances can be retracted when not needed in order to reduce the size of the computer input device.

4. A method for adding at least two axes of movement to each of the two grips of a hand-held computer input device.

5. The method of claim 4, where a first axis of movement is a back and forth rocking motion and a second axis of movement is an in and out rolling motion.

6. The method of claim 5, where the computer input device operates in a pointing mode where the rocking motion moves the display focus in the plane of the display, and the rolling motion moves the display focus in to and out of the plane of the display.

7. The method of claim 5, where the computer input device operates in a typing mode where a subset of the keys found on a common computer keyboard are assigned to the touch sensitive areas based on the grips' rocking position, and normal, shift, or control modifiers found on a common computer keyboard are attached to the touch sensitive areas based on the grips' rolling position.

8. A hand-held apparatus for computer pointing and typing input that rests in a user's hands so the user's fingers and thumbs are not required for gripping to remain free for actuating touch sensitive areas and where said resting means are protuberances on the back of the apparatus that rest in the crook between the thumbs and index fingers of a user's hands.

9. The apparatus of claim 8, where additional resting means wrap around the back of a user's hands to more positively affix the apparatus to a user's hands.

10. The apparatus of claim 8, where the protuberances can be retracted when not needed in order to reduce the size of the apparatus.

11. An apparatus with at least two axes of movement for each of two grips for a hand-held computer pointing and typing input device.

12. The apparatus of claim 11, where a first axis of movement is a back and forth rocking motion and a second axis of movement is an in and out rolling motion.

13. The apparatus of claim 12, where the computer input device operates in a pointing mode where the rocking motion moves the display focus in the plane of the display, and the rolling motion moves the display focus in to and out of the plane of the display.

14. The apparatus of claim 12, where the computer input device operates in a typing mode where a subset of the keys found on a common computer keyboard are assigned to the touch sensitive areas based on the grips' rocking position, and normal, shift, or control modifiers found on common computer keyboards are attached to the touch sensitive areas based on the grips' rolling position.
